(19) United States
(12) Patent Application Publication
(10) Pub. No.: US 2003/0052487 A1
(43) Pub. Date: Mar. 20, 2003

(54) Method and means of generating , storing , and using electricity by a motion driven turbine in a fluid medium

(76) Inventor: Fred Weingarten, Westford, VT (US)

Correspondence Address: FRED WEINGARTEN, 19 MACHIA HILL ROAD, WESTFORD, VT, 05494, US

(21) Appl. No.: 10/228,352

(22) Filed: Aug. 27, 2002

Related U.S. Application Data
(60) Provisional application No. 60/323,795, filed on Sep. 20, 2001.

(51) Int. Cl. H02P 9/04; F03B 13/00

(52) U.S. Cl. 290/54

(57) ABSTRACT

A turbine-electric generator-battery/storage assembly mounted on any surface of ,or in, any device in motion to capture the fluid medium “winds” generated by said motion, to spin said turbine. The turbine, in turn, spins an electric generator that transmits its electricity to a storage device/battery that in turn is connected to a plug-mold for downloading to an inverter, into the power grid. The inverter can be part of, or separate from, this assembly, and battery can be removed and plug-mold used for a direct power source.

### BACKGROUND OF THE INVENTION

The field of endeavor is the production of electric power for primarily grid use by means of man-made motion turbine power.

Prior art used natural wind turbine power to generate small amounts of electricity as in U.S. Pat. Nos. 5,506,453, 4,970,404, or 4,963,761. However, none of these applications used man-made wind to generate large collective power sources to be downloaded into the electric grid system and provide an alternative clean power source that can be used by many, not just the direct wind-mill user. My invention solves this problem.

### BRIEF DESCRIPTION OF THE SEVERAL VIEWS OF THE DRAWING

FIG. 1 shows the side view of a preferrred automobile embodiment. A roof mounted fan turbine (a), with a screened intake (b), spins a generator (c), that transmits power into battery/storage device (e), that is connected to a plug-mold (f) for downloading . The front windshield is depicted (g).

FIG. 2 shows the front view of same, with turbine (a) connected to generator-battery-plugmold (b) , housing (c) and front windshield (d).

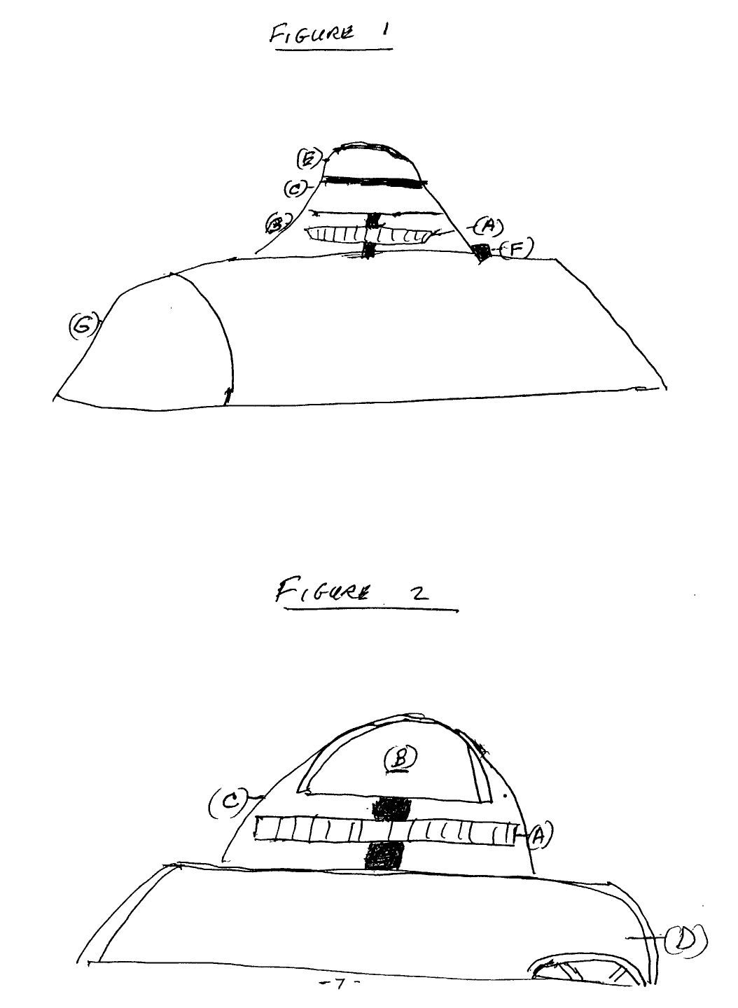

Method and means of generating, storing, and using electricity by a motion driven turbine in a fluid medium: A method of generating electricity that would harness the mechanical energy of fluid motion by using any spinning blade/fan turbine, mounted on any device in motion. Such turbine would be linked, by rotating shaft. to turn an electric generator that can direct electricity produced, to a storage device, e.g. a battery, which in turn can download electricity stored. Said turbine would be mounted on any surface/part of moving device, that would allow it to be exposed to moving fluid, such as air or water. Some examples would be to the roof of an automobile or truck/trailer/bus; or to the exterior of an airplane or train-all to harness passing air as these devices move. Also, to the submerged portion of a boat/ship to use passing water to spin said turbine, as these vehicles move, or mount at the waterline so as to harness both air and water passing along with wave motion. Turbines could also be located inside or be part of the exterior of these “vehicles”, and use intake tubes/devices to guide moving fluids through turbines to spin them. Obvious improvements are many, e.g. combining multiple turbines, multiple generators, battery banks, combining helical with flat turbines, varying pitch and tilt of turbines to maximize energy output, utilizing turbine's mechanical energy to help propel vehicle or to aid in recharging vehicle's battery , utilizing the turbine's spin to produce electricity with any new method generator, etc.. However, the primary purpose of this invention would be to transfer stored electricity produced by turbine spin, and then transmitted to the electric power grid for use. For example, this transmission could be accomplished through download leads from the storage device to an inverter and then directly into our electric power grid; or to drop off or exchange charged for uncharged batteries for later downloading. Metering equipment could register amounts of power transferred to grids so sellers/providers could be credited or compensated by power companies/government managers/etc.. A preferred drop-off site might be gasoline service stations for convenience, even while filling up with gas; or to power company and/or government coordinated sites. Universal hook-ups or tie-ins to transfer electricity to the grid both quickly and easily and register such sale would be a preference. Also feasible, could be downloading to home or factory electrical systems directly, or for appliances to be plugged into the storage battery, e.g. for camping. Such methods could be a very economical and environmentally friendly form of electricity production from a currently untapped source—man-made motion byproducts of “wind and waves” that are now wasted. Design of invention should be aesthetic, aerodynamic, and compact and light as possible. It could be one single unit or be comprised of connected individual components, e.g. turbine/generator unit on the roof of a car and battery/download in the trunk of the car, etc.. Units should easily be installed if retrofitting vehicles, as well as affordable. Safety in design is paramount, e.g. screening at turbine intakes, blade areas, and exhaust to protect humans/wildlife, as well as electric shock prevention through proper grounding, materials, and wiring. Quick and easy downloading should be imperative. Transfer cables from the power grid to the storage battery or vice versa, from the battery to the grid, with universal plug-ins , could be an especially user friendly method, increasing popularity of this method of energy production. Reduction on dependence of foreign energy sources, would certainly be a goal, and government promotion/rewards, could serve the national interest of this process. The natural wind driven turbines commonly available have not been broadly accepted due to the uncertainty of the wind, high costs, aesthetics, etc., and thus, have been major roadblocks to popularity. However, utilizing the steady man-made “winds” of motion could be well accepted and become a major new energy source. Following is a preferred embodiment drawing of an automobile roof-mounted turbine-generator-battery unit:

I claim the following with regards to the entitled: Method and means of generating, storing, and using electricity by a motion driven turbine in a fluid medium:

1. A method of generating electricity that would harness the mechanical energy of fluid motion by using any spinning blade/fan turbine, mounted on any device in motion, such turbine would be linked, by rotating shaft. to turn an electric generator that can direct electricity produced, to a storage device, e.g. a battery, which in turn can download electricity stored, or used directly.

2. Said turbine would be mounted on any surface/part of moving device, that would allow it to be exposed to moving fluid, such as air or water, or both, with obvious improvements many, e.g. combining multiple turbines, multiple generators, battery banks, combining helical with flat turbines, varying pitch and tilt of turbines to maximize energy output, utilizing turbine's mechanical energy to help propel vehicle or to aid in recharging vehicle's battery utilizing the turbine's spin to produce electricity with any generator.

3. Electric transmission to be accomplished through download leads or plug-molds from the storage device to an inverter and then directly into our electric power grid; or drop-off or exchange charged for uncharged batteries for later downloading, or directly into a user mode, or downloading to home or factory electrical systems directly as reverse metering, or for appliances to be plugged into the storage battery directly.
